(19) United States
(12) Patent Application Publication
(10) Pub. No.: US 2006/0134442 A1
(43) Pub. Date: Jun. 22, 2006

(54) Method for electroless plating

(76) Inventors: Minoru Sugiyama, Osaka-fu (JP); Susumu Hara, Osaka-fu (JP)

Correspondence Address: THE WEBB LAW FIRM, P.C., 700 KOPPERS BUILDING, 436 SEVENTH AVENUE, PITTSBURGH, PA, 15219, US

(21) Appl. No.: 10/540,451

(22) PCT Filed: Dec. 26, 2003
(86) PCT No.: PCT/JP03/16903

§ 371 Date: Dec. 15, 2005

(30) Foreign Application Priority Data
Dec. 27, 2002 (JP) 2002379942
Dec. 5, 2003 (JP) 2003408067

(51) Int. Cl. B32B 15/08

(52) U.S. Cl. 428/457; 427/304

(57) ABSTRACT

A method for carrying out an electroless plating onto a polymer electrolyte, characterized in that it comprises a swelling step as a pre-treatment step of swelling the polymer electrolyte with a good solvent or a mixed solvent containing a good solvent, and the resultant swollen polymer electrolyte has a specific shape and a thickness 110% or more that of the polymer electrolyte in a dry state. The method allows the preparation of a laminate comprising a metal layer and a polymer electrolyte layer which can be used in an application field requiring a bending greater than that in a conventional field.

The description of this application claims benefit of priority based on Japanese Patent Applications No. 2002-379942 and No. 2003-408067 the entire same contents of which are incorporated by reference herein.

### TECHNICAL FIELD

The present invention relates to a method for electroless plating for forming a metal layer being compact and having a large surface area onto a polymer electrolyte, and laminate comprising the metal layer and the polymer electrolyte layer.

### BACKGROUND ART

Electroless plating method is useful, since the method can form easily a metal layer onto a polymer electrolyte, whereby a laminate comprising the metal layer and the polymer electrolyte can be obtained as the laminate which may be used as a bendable actuator.

### DISCLOSURE OF THE INVENTION

Since a bendable actuator, particularly a polymer actuator may be used as a driving part for a catheter because of its flexibility, and it is particularly watched in recent years. As the above-described actuator, for example, there is used such an actuator made of a laminate composed of an ion-exchange resin membrane being a polymer electrolyte and metal electrodes bonded mutually on the surface of the polymer electrode, an electric potential difference is applied across the metal electrodes in a hydrous condition of the ion-exchange resin, whereby a flexure or deformation is caused in the ion-exchange resin molded article to function as an actuator (e.g. see Japanese Patent No. 2961125, pages 1 to 9).

As a method for manufacturing a laminate being such actuator as described above, electrodes are formed in accordance with an electroless plating method which deposits a metal wherein a surface roughening treatment is applied on an ion-exchange resin membrane being a polymer electrolyte, then the ion-exchange resin is immersed in water to swell it, a metal complex such as platinum complex or gold complex is allowed to adsorb to the ion-exchange resin membrane swollen with water in an aqueous solution, and the metal complex adsorbed is reduced by a reducing agent, such adsorption/reduction steps are repeated. Each of the adsorption/reduction steps are repeated six or more times in order to assure an amount of metal on the polymer electrolyte being sufficient for displacing flexures or the like as the actuator. In the laminate composed of the polymer electrolyte and the electrode layer thus obtained, a metal layer is grown in the interior direction of the polymer electrolyte to form the electrode, and a section of the electrode layer forms a fractal structure in the interface of the polymer electrolyte and the electrode layer. As to the fractal structure, refer to, for example, the description in P 932 to 938 of “Biomimetics Handbook” compiled by Yoshihito Nagata; first edition, published by N T S Co., Ltd. on Sep. 13, 2000. According to such fractal structure, an electrical double layer is formed in the interface of the metal layer and the polymer electrolyte layer, whereby a displacement such as good flexure and the like can be achieved.

Concerning a polymer actuator, however, an application for wide intended purposes of artificial muscles or a variety of mechanisms is studied recently, it has been desired to apply such polymer actuator to an application field requiring a wider width of deflection than that in an actuator to be used for a catheter, and a larger amount of displacement such as a bending and the like is required than that in the laminate obtained in the above-described electroless plating. Furthermore, it is desired also to use an actuator having a larger amount of displacement for a catheter due to easier operating conditions.

For obtaining a laminate by which a larger bending amount than that in a conventional field can be achieved as an actuator, it may be considered to increase an amount of a metal deposited on a polymer electrolyte in accordance with a manner for increasing the number of times for repeating adsorption/reduction steps in the above-described electroless plating method. However, there is a limit in an amount of a metal to be deposited by the manner for increasing the number of times for repeating adsorption/reduction steps, so that it is difficult to intend a further improvement in a bending amount of a laminate obtained by the above-described electroless plating.

An object of the present invention is to provide a method for electroless plating by which a laminate comprising a metal layer and a polymer electrolyte layer which can be used in an application field wherein a bending greater than that in a conventional field is required.

### BEST MODE FOR CARRYING OUT THE INVENTION

As a result of eager study, the present inventors have found that the above-described problems can be solved by applying a method for electroless plating;

the method for electroless plating is that for applying to a polymer electrolyte;

the method for electroless plating contains a pre-treatment step;

the pre-treatment step is a swelling step for swelling the polymer electrolyte by means of permeation of a good solvent or a mixed solvent containing a good solvent; and

the swelling step is a step for making a thickness of the polymer electrolyte in a swollen state to be 110% or more that of the polymer electrolyte in a dry state;

and thus, the present invention has been completed. More specifically, the method for electroless plating is a method for electroless plating onto a polymer electrolyte, characterized in that it comprises a swelling step as a pre-treatment step of swelling the polymer electrolyte with a good solvent or a mixed solvent containing a good solvent,

the resultant swollen polymer electrolyte has a specific shape, and

a thickness in a swollen state is 110% or more that of the polymer electrolyte in a dry state. The method allows the preparation of a laminate which can be used in an application field requiring a bending greater than that in a conventional field.

Since the swelling step is carried out as a pre-treatment step in the method for electroless plating according to the present invention, a laminate comprising a metal layer and a polymer electrolyte which exhibits a remarkable displacement (bending) in the case where it is driven as an actuator can be obtained. Besides, the above-described laminate can be used as a driving part in an application field requiring a bending greater than that in a conventional field. In addition, since the laminate of the present invention is the one wherein an electrical double layer capacity in an interface of the electrode layer and the polymer electrolyte layer is 3.0 mF/cm² or more in the case when a dry film thickness of the polymer electrolyte is converted into 170 μm, or 2.0 F/cm³ or more according to a constant current discharge method, displacement such as bending as an actuator is remarkable, whereby the same mechanical energy as that of the prior art can be obtained by a low applied voltage. Thus, it becomes also possible to decrease significant energy costs.

The present invention is a method for electroless plating onto a polymer electrolyte, characterized by a swelling step for swelling the polymer electrolyte by permeating a good solvent or a mixed solvent containing a good solvent into the polymer electrolyte as a pre-treatment for the electroless plating to the polymer electrolyte, whereby the resultant swollen polymer electrolyte has a predetermined shape and a thickness 110% or more in a swollen state than that of the polymer electrolyte in a dry state. After the above-described swelling step being a pre-treatment was carried out, an adsorption step for allowing a metal complex to adsorb to a polymer electrolyte, and a reduction step for reducing the metal complex adsorbed with a reductant solution to deposit a metal are implemented as a formation of a metal layer in accordance with the method for electroless plating. After the reduction step, it is preferred to carry out a washing step for washing the polymer electrolyte on which a metal is deposited in order that steps to be carried out after the reduction step can be easily effected by removing the reductant.

(Swelling Step)

In the method for electroless plating of the present invention, first a swelling step is carried as a pre-treatment, the swelling step being the one for swelling a polymer electrolyte by permeating a good solvent or a mixed solvent containing a good solvent into the polymer electrolyte, and the resultant swollen polymer electrolyte having a predetermined shape and a thickness in a swollen state thereof being 110% or more that of the polymer electrolyte in a dry state. The good solvent is used in corresponding to a composition of the polymer electrolyte. In the swelling step, the good solvent permeates into the polymer electrolyte, whereby the polymer electrolyte becomes a swollen state. In the swelling step, since a good solvent or a mixed solvent containing a good solvent is used, remarkable swelling of polymer electrolyte appears in comparison with a case of using a poor solvent. Due to the swelling, a size of a film-like or column-like polymer electrolyte increases totally while maintaining substantially the same outline thereof in the case where no particular processing such as coating is applied to the polymer electrolyte, while when a particular processing such as coating is applied to the polymer electrolyte, a part on which the particular processing is not applied becomes large, so that there is a case of appearing displacement such as a bending. In the swelling step, when a polymer electrolyte forms no shape in a swollen state, it is difficult to form a metal layer in the following step. Accordingly, it is required that a polymer electrolyte should be swollen by means of permeation due to a good solvent or a mixed solvent containing a good solvent in a state wherein the polymer electrolyte has substantially the same shape or a predetermined shape such as a deformed shape of a bending or the like before the swelling thereof. In the swelling step, a thickness of the polymer electrolyte in a swollen state as to that with respect to a surface of the polymer electrolyte on which a metal layer is to be formed differs dependent upon types of polymer electrolytes. However, it is preferred that a thickness of the swollen polymer electrolyte is 110 to 3000% with respect to the polymer electrolyte in a dry state in order to make an operation easy in case of shifting to an adsorption step or a reduction step to be followed to the swelling step, and more preferable is such that a thickness of the swollen polymer electrolyte is 120 to 1000% with respect to the polymer electrolyte in a dry state. Furthermore, when the good solvent reacts with a metal complex used in the adsorption step to inhibit formation of a metal layer, it is preferred that a thickness of the polymer electrolyte in a swollen state is 120 to 300% with respect to that of the polymer electrolyte in a dry state. Moreover, a ratio of a thickness of a polymer electrolyte in a swollen state with respect to that of the polymer electrolyte in a dry state may be represented by a rate wherein a polymer electrolyte in a dry state is swollen at a how much degree, and hereinafter referred to as “a degree of swelling”. For instance, when a thickness of a swollen polymer electrolyte is 110% with respect to that of the polymer electrolyte in a dry state, its degree of swelling is 10%.

The above-described polymer electrolytes are not specifically limited so far as it is principally prepared from a polymer material, but an ion-exchange resin is preferable for allowing a metal complex to be adsorbed sufficiently. The ion-exchange resin is not specifically limited, and well-known resins may be used. Namely, those prepared by introducing a hydrophilic group such as sulfonic acid group, and carboxyl group into polyethylene, polystyrene, fluorocarbon resin and the like may be used. Particularly preferable as a polymer actuator is a cation-exchange resin such as fluorocarbon resin into which sulfonic acid group and/or carboxyl group is introduced which is used as the above-described ion-exchange resin. Because the resultant cation-exchange resin has moderate rigidity, a high ion-exchange amount, good chemical proof, and good durability with respect to repeated bending. A specific example of the above-described ion-exchange resins includes perfluorocarboxylic acid resin, and perfluorosulfonic acid resin. For example, Nafion resin (perfluorosulfonic acid resin manufactured by DuPont Corporation), and Flemion (perfluorocarboxylic acid resin or perfluorosulfonic acid resin manufactured by Asahi Glass Co., Ltd.) may be used. The above-described polymer electrolyte may be formed into a polymer electrolyte molded article having a desired shape such as film-like, plate-like, cylinder-like, column-like, tube-like and the like profiles suitable for a laminate obtained by a method for electroless plating.

According to the above-described swelling step, the polymer electrolyte is permeated with a good solvent or a mixed solvent containing a good solvent, whereby such swelling that the resultant swollen polymer electrolyte has a desired shape, and a thickness of the polymer electrolyte in a swollen state is 110% or more than that of the polymer electrolyte in a dry state is achieved. As a result of such swelling that a thickness of the polymer electrolyte in a swollen state is 110% or more than that of the polymer electrolyte in a dry state, a degree of freedom in segmental motion as to a side chain having a functional group increases in a resin component forming a polymer electrolyte. As a consequence of such increase in degree of freedom, it may be considered that a metal complex is easily adsorbed from a surface of the polymer electrolyte to the interior thereof in an adsorption step of a method for electroless plating, while a reductant in a reductant solution is easily adsorbed from the surface of the polymer electrolyte to the interior of the polymer electrolyte in also a reduction step, so that Brownian motion of the metal complex and the reductant become easy.

Moreover, in a laminate wherein a metal layer is formed on a polymer electrolyte obtained in accordance with the method for electroless plating in which the swelling step is carried out, when the metal layer is used as an electrode layer, its electrical double layer capacity is larger in comparison with that of a conventional case. In a metal layer of the laminate obtained in accordance with the method for electroless plating, it may be considered that a section of the metal layer forms a structure of a larger patterned indented surface than that of a conventional fractal shape in the interface of the polymer electrolyte and the metal layer, and even after the laminate was obtained and in the case where the polymer electrolyte was shrunk, the fractal structure formed at the time of swelling is still held on.

The above-described good solvent means a solvent allowing a polymer to swell well, so that a good solvent is different dependent on types of polymer constituting a polymer electrolyte. Accordingly, suitable solvent species may be used according to a composition of a polymer electrolyte applied in corresponding to a use application and the like of a laminate prepared finally in accordance with the method for electroless plating. The good solvent may be admixed with a plurality of good solvents. An example of good solvents includes methanol, dimethyl sulfoxide, N-methylpyrrolidone, dimethylformamide, ethylene glycol, diethylene glycol, glycerin and the like. When the polymer electrolyte is perfluorocarboxylic acid resin or perfluorosulfonic acid resin, methanol, ethanol, propanol, hexafluoro-2-propanol, diethylene glycol, or glycerin may be used. Particularly, when the polymer electrolyte is perfluorocarboxylic acid resin or perfluorosulfonic acid resin in the swelling step, it is preferred that methanol or a solvent containing methanol is allowed to permeate into the polymer electrolyte, whereby a thickness of the polymer electrolyte in a swollen state is made to be 110% or more with respect to that of the polymer electrolyte in a dry state. This is because methanol allows easily the polymer electrolyte to swell, and further, methanol is easily handled, whereby workability thereof is favorable.

Only a good solvent or a mixed solvent containing a good solvent may be used for allowing a polymer electrolyte to swell in the swelling step so far as it may achieve that a thickness of the polymer electrolyte in a swollen state is made to be 110% or more with respect to that of the polymer electrolyte in a dry state. As a result of swelling a polymer electrolyte, a degree of crystallization in the polymer electrolyte decreases, and particularly, intertwist of side chains each having functional groups is moderated, whereby a degree of freedom in segmental motion with respect to the side chains increases. For this reason, it may be considered that in a laminate comprising a metal layer and a polymer electrolyte obtained in accordance with the method for electroless plating wherein the swelling step is a pre-treatment, ions are more efficiently transferred, whereby a remarkable displacement is achieved.

A mixed solvent containing a good solvent used for the polymer electrolyte may be the one being a mixture of a good solvent in an appropriate ratio and another solvent wherein a mixed ratio of the good solvent and the other solvent is not particularly restricted so far as such requisite that a thickness of the polymer electrolyte in a swollen state can be made to be 110% or more than that of the polymer electrolyte in a dry state. This is because an amount of displacement (a bending amount) becomes low in the case where a thickness of the polymer electrolyte in a swollen state is less than 110% with respect to that of the polymer electrolyte in a dry state, if a laminate obtained by the method for electroless plating is driven as an actuator. The above-described other solvent differs from a good solvent used for the polymer electrolyte, and it may be water or an organic solvent so far as it may be the one which can maintain a stable mixed condition together with the good solvent. When an adsorption step following to the swelling step is carried out in a metal complex aqueous solution, it is preferred to use water as the other solvent because there is no deposition of a metal complex as in inhibition in adsorption of a metal complex.

Since the polymer electrolyte can be easily swollen in the case where the polymer electrolyte is perfluorocarboxylic acid resin or perfluorosulfonic acid resin and a good solvent or a mixed solvent containing a good solvent being a swelling solvent wherein the former and latter good solvents are methanol, it is preferred to contain 5 to 100% by weight of methanol in the swelling solvent. In the case where anion-exchange capacity of the perfluorocarboxylic acid resin or perfluorosulfonic acid resin is 1.8 meq/g, it is more preferable to contain 5 to 40% by weight of methanol in the swelling solvent since remarkable swelling of polymer electrolyte can be achieved easily. And also, in the case where an ion-exchange capacity of the perfluorocarboxylic acid resin or perfluorosulfonic acid resin is 1.4 meq/g, it is more preferable to contain 100% by weight of methanol in the swelling solvent.

When only a good solvent is used, but not a mixed solvent for the swelling solvent, polymer electrolyte may be swollen properly in a desirable temperature range, although a condition differs from one another dependent upon types of good solvents. It is preferred that the polymer electrolyte is immersed in a good solvent at a temperature at which the polymer electrolyte is never gelled. When methanol is used as the swelling solvent, a swelling step is preferably carried out at room temperature.

In a pretreatment step, a means for allowing a good solvent or a mixed solvent containing a good solvent to permeate into a polymer electrolyte is not particularly restricted as far as it is satisfied that the resultant swollen polymer electrolyte has a predetermined shape, and that a thickness of the polymer electrolyte in a swollen state can be made to be 110% or more with respect to that of the polymer electrolyte in a dry state. For instance, a manner for immersing a polymer electrolyte into a good solvent or a mixed solvent containing a good solvent may be applied as the above-described means. A manner for applying a good solvent or a mixed solvent containing a good solvent to a surface of a polymer electrolyte may be adopted as the above-described means. It is preferred to apply a manner for immersing a polymer electrolyte into a good solvent or a mixed solvent containing a good solvent as the above-described means, because workability of the manner is easy.

The above-described swelling step may also be carried out by using the good solvent containing 1 to 30% by weight, and preferably 1 to 10% by weight of a basic salt.

A swelling step by the use of the basic salt aqueous solution having the above-described ratio may be applied before or after the swelling step by the use of the good solvent. When the swelling step is carried out by using a solution containing a basic salt as described above, a degree of swelling of polymer electrolyte can be increased in comparison with the case where only the swelling step is carried out by using only a good solvent. In this respect, it may be considered that a good solvent moderates intertwist in side chains of a polymer electrolyte, whereby the polymer electrolyte is swollen. On the one hand, it may be considered that ionic substances produced by dissolution of a basic salt in a solvent moderate intertwist of functional groups of a polymer electrolyte thereby allowing the polymer electrolyte to swell. In other words, intertwist in functional groups of a polymer electrolyte which could not be swollen by a good solvent alone may further be moderated by the basic salt. As a result, a high degree of swelling can be synergistically achieved in a polymer electrolyte.

There is no limitation as to use of the basic salt so far as it has a property of dissolving into a good solvent or water. A basic salt which is dissolved only into water can achieve the advantageous effects of the present invention by adding further a swelling step by the use of a basic salt aqueous solution as mentioned above. A specific example of these basic salts includes LiOH, NaOH, aqueous ammonia, tetramethylammonium hydroxide (TMAOH), tetraethylammonium hydroxide (TEAOH), tetrapropylammonium hydroxide (TPAOH), and tetrabutylammonium hydroxide (TBAOH). Among these basic salts as mentioned above, the optimum ionic liquid or salt may be selected in corresponding to a polymer electrolyte to be applied. For instance, when the polymer electrolyte is perfluorocarboxylic acid resin or perfluorosulfonic acid resin, it is preferred to use a basic salt such as TEAOH, TPAOH, and TBAOH thereby allowing the polymer electrolyte to swell. Even when a polymer electrolyte has the same component as that of another polymer electrolyte, if their ion-exchange capacities differ from one another, their optimum basic salts differ also from one another. For example, when a trade name “Flemion” (manufactured by Asahi Glass Co., Ltd.) being a perfluorocarboxylic acid resin is used for a polymer electrolyte, TEAOH or TPAOH is suitable for 1.4 meq/g ion-exchange capacity type resin, while TBAOH is suitable for 1.8 meq/g ion-exchange capacity type resin. This is because it may be considered that a cluster size of the ion-exchange resin matches with a size of the basic salt according to such combination as mentioned above.

The basic salts are not specifically restricted as far as they can allow the polymer electrolyte to swell. For instance, when the basic salt is a salt containing multivalent ions such as copper ion, and iron ion, a molecule containing a polycycle as a ligand is used to introduce a cation being a multivalent ion into a complex, whereby the basic salt as described above may be used in the present invention. In this respect, however, if a cation in a solution is monovalent, there is no need to coordinate a giant ligand to a central atom, and hence, it is preferred that the basic salt is a monovalent salt.

As mentioned above, such swelling step that an aqueous solution of a salt is immersed into a polymer electrolyte to swell the polymer electrolyte, and the salt is the one containing an ion being ion-exchangeable with an exchange group in an ion-exchange resin constituting the polymer electrolyte may be carried out as a pre-treatment for electroless plating with respect to the polymer electrolyte. For instance, when the polymer electrolyte is a cation-exchange resin, ions exchangeable with sulfo group or carboxyl group being an exchange group are tetramethylammonium ion, tetraethylammonium ion and the like as mentioned above. An aqueous solution of a salt for immersing into a polymer electrolyte may be a salt containing an ion exchangeable with an exchange group involving an anion-exchange resin in the case where the polymer electrolyte is the anion-exchange resin.

As mentioned above, when a swelling step is carried out by using a solution containing a basic salt, a degree of swelling in a polymer electrolyte is higher than that in case of a good solvent only, so that the number of repeating an adsorption step and a reduction step to be followed to the swelling step according to the method for electroless plating can be reduced. More specifically, it is preferred that plural times of the adsorption steps and the reduction steps are required, among others, these steps are preferably repeated over four or more times, and more preferable is six or more times in order to form a good metal layer on a polymer electrolyte in the case where the swelling step is carried out by the use of a good solvent alone. On the other hand, however, since a degree of swelling is high in the case where the swelling step is carried out by using a solvent containing a basic salt, a metal layer having an equal quality to that of the case as described above can be formed by one each time of the adsorption and reduction steps without repeating these steps as mentioned above. It may be considered that intertwist in side chains and functional groups of a polymer electrolyte is disengaged, whereby a degree of swelling becomes high, so that metal adsorption to the polymer electrolyte becomes easy. In other words, it may be considered that a sufficient amount of a metal complex is adsorbed to a polymer electrolyte by carrying out only one time each of the adsorption and reduction steps, and such metal complex is reduced to form a metal layer, whereby the metal layer having equal quality to that of a case wherein the adsorption step and the reduction step are repeated is obtained, even if only a single adsorption step and reduction step are carried out.

(Method for Electroless Plating)

After completing the above-described swelling step, a polymer electrolyte wherein a thickness of the polymer electrolyte in a swollen state is 110% or more than that of the polymer electrolyte in a dry state is subjected to an adsorption step for allowing a metal complex to adsorb to the polymer electrolyte in a swollen state, and then a reduction step for allowing a reductant solution to be in contact with the polymer electrolyte to which a metal complex has been adsorbed. When the reduction step is carried out after completing the adsorption step, a metal complex is reduced to deposit on a polymer electrolyte as a metal, whereby a metal layer is formed to obtain a laminate. When a method for electroless plating is applied to a polymer electrolyte after the swelling step was completed, a method for manufacturing a laminate according to the present invention is achieved. Namely, it is the method for manufacturing a laminate comprising a metal layer and a polymer electrolyte, characterized in that it comprises a swelling step for swelling the polymer electrolyte by permeating a good solvent or a mixed solvent containing a good solvent into the polymer electrolyte as a pre-treatment for the electroless plating to the polymer electrolyte, whereby the resultant swollen polymer electrolyte has a predetermined shape and a thickness 110% or more in a swollen state than that of the polymer electrolyte in a dry state, subsequently an adsorption step for allowing a metal complex to adsorb to the polymer electrolyte, and a reduction step for allowing a reductant solution to be in contact with the polymer electrolyte to which the metal complex has been adsorbed being carried out, whereby a metal layer is formed.

(Adsorption Step)

An adsorption step in the method for manufacturing a laminate according to the present invention is not specifically restricted so far as it is a step for allowing a metal complex to be in contact with a polymer electrolyte which is a swollen polymer electrolyte having a predetermined shape and a thickness of the polymer electrolyte in a swollen state being 110% or more than that of the polymer electrolyte in a dry state. The adsorption step may be effected by applying a metal complex solution to a polymer electrolyte, but it is preferable to effect the adsorption step by immersing a polymer electrolyte which has been swollen to have a film thickness 110 to 300% with respect to a dry film thickness thereof according to the swelling step, because the operation therefor is easy.

A metal complex solution in the adsorption step is not specifically limited as far as the solution contains a complex of a metal from which a metal layer is formed by reduction and the resulting metal layer can function as an electrode layer. As to the metal complex, since a metal having a low ionization tendency is stable electrochemically, it is preferred to use a metal complex such as gold complex, platinum complex, palladium complex, rhodium complex, and ruthenium complex. Since a metal deposited is used as an electrode in water, it is preferred to be a metal complex made of a noble metal which has good electrical conductivity and is sufficiently stable electrochemically. Moreover, the metal complex is preferably gold complex made of gold in which electrolysis of water occurs with difficulty. In the above-described metal salt solution, although its solvent is not specifically limited, it is preferred that a major component of the solvent is water, because such solvent dissolves easily a metal salt and handling therefor is easy, so that the above-described metal salt solution is preferably a metal salt aqueous solution. Accordingly, the above-described metal complex solution is preferably a metal complex aqueous solution, particularly it is preferably a gold complex aqueous solution or a platinum complex aqueous solution, and more preferably it is the gold complex aqueous solution.

Although conditions of a temperature, an immersion time and the like are not specifically restricted in the above-described adsorption step so far as it is a step for allowing a metal complex to adsorb to a polymer electrolyte wherein a thickness of the polymer electrolyte in a swollen state is 110% or more than that of the polymer electrolyte in a dry state, it is preferred that the temperature is 20° C. or higher, because a polymer electrolyte is efficiently swollen at that temperature. Furthermore, in the above-described adsorption step, a metal complex solution may contain a good solvent for a polymer electrolyte in order that a metal complex is easily adsorbed into the polymer electrolyte.

(Reduction Step)

A reductant solution used in the present invention is not specifically restricted so far as a reductant is dissolved in the solution irrespective of a form of polymer electrolyte. The above-described reductant may suitably be selected to use in corresponding to types of a metal complex used in a metal complex solution to be adsorbed to a polymer electrolyte. For example, sodium sulfite, hydrazine, sodium borohydride and the like may be used. In case of reducing a metal complex, an acid or an alkali may be added as circumstances demand. A concentration of the reductant solution may be in such that the solution contains a reductant an amount of which is sufficient for obtaining an amount of a metal which is deposited by reduction of a metal complex, and it is not specifically limited. It is, however, possible to use such a reductant solution having the same concentration as that of a metal salt solution used in the case where an electrode is formed by usual electroless plating. Moreover, the reductant solution may contain a good solvent for a polymer electrolyte.

In the method for manufacturing a laminate according to the present invention, when one time each of an adsorption step and a reduction step are carried out, a laminate comprising a metal layer and a polymer electrolyte layer can be obtained. However, when the adsorption step and the reduction step are further repeated, a displacement amount (bending amount) in the case where the laminate is driven as an actuator as well as an electrical double layer capacity in the interface of a metal layer and a polymer electrolyte layer can be made larger than that of the prior art. In case of repeating the adsorption step and the reduction step, it is preferred to carry out a washing step after the reduction step for the sake of removing a reductant from a polymer electrolyte to implement easily the adsorption step. The washing step is not specifically restricted, but the washing may be carried out with water and in this case, a reductant may also be removed.

(Laminate)

In a laminate obtained in accordance with the method for manufacturing a laminate of the present invention, a more uneven structure than a conventional fractal structure is formed on a section of a metal layer in the interface of a polymer electrolyte and the metal layer. Accordingly, when the resultant metal layer formed on the polymer electrolyte is used as an electrode, a high electrical double layer capacity can be obtained. Namely, the resulting laminate is a laminate of the present invention which comprises an electrode layer and a polymer electrolyte layer, and has a value of an electrical double layer capacity in the interface of the electrode layer and the polymer electrolyte layer of 3 mF/cm² or more in the case where a thickness of the laminate is converted to 170 μm; or the laminate of the present invention which has an electrical double layer capacity according to constant current discharge method is 2.0 F/cm³ or more. It is to be noted that a thickness of a laminate is not specifically limited in the laminate of the present invention.

When a reduction step is carried out through the swelling step, there is such a case where a metal complex penetrates into the interior of a polymer electrolyte, they turn into particulate metal materials by means of the reduction step, and these particulate metal materials accumulated each other, whereby a metal component is formed on the electrolyte. Since a metal layer is formed on a polymer electrolyte through the process as mentioned above, the interface between the metal layer and the electrolyte layer is not necessarily clear in the laminate of the present invention, but there is a region wherein a metal component is rich in the vicinity outside a polymer electrolyte, or a structure wherein an electrolyte component becomes gradually rich with approaching the center of the electrolyte. More specifically, a metal layer in the laminate of the present invention does not necessarily require that a definite metal component exists on an electrolyte layer as a layer, but it is sufficient that at least metal components existing in the vicinity outside the electrolyte are connected electrically with each other, whereby a part having a good electrical conductivity is formed.

A laminate of the present invention has an electrical double layer capacity of 3 mF/cm² or more in the case where a thickness of the laminate is converted to 170 μm. In this respect, the upper limit of the electrical double layer capacity is not limited as far as displacement such as a bending and the like is possible as an actuator. The higher value of an electrical double layer capacity in an electrode layer (metal layer) of a laminate brings about the easier transfer of ions contained in the polymer electrolyte in the case when a voltage is applied to the electrode layer, whereby the laminate exhibits a remarkable bending (displacement) as an actuator, and reactivity in bending becomes rapid, so that it is suitable for practical use application wherein a remarkable bending is required. The electrical double layer capacity is preferably 5 mF/cm² or more for obtaining a more remarkable bending, and more preferable is 10 mF/cm² or more. In addition, since the laminate of the present invention can obtain a conventional displacement amount by a low applied voltage, its energy efficiency is good. A value of an electrical double layer capacity wherein a thickness of a laminate is converted to 170 μm is obtained by multiplying a value of an electrical double layer determined in actual measurement by a value obtained by dividing a thickness (d) [μm] of the electrical double layer capacity used in the measurement by 170 μm (170/d). An actual measurement of an electrical double layer capacity in the laminate may be determined in accordance with a well-known cyclic voltammetry wherein a well-known device is used.

Different from an evaluation by an electrical double layer capacity according to the above-described cyclic voltammetry, another evaluation by an electrical double layer capacity may be effected on a laminate of the present invention in accordance with a constant current discharge method. “Electrical double layer capacity” in accordance with a constant current discharge method mentioned in the present invention means a value measured pursuant to standard No. EIAJ RC-2377 (established April 2000, testing method for electrical double layer capacitor, 3.3.1 constant current discharge method) in Standards of Japan Electronic Industry published by Incorporated Body, Electronic Industries Association of Japan, and corresponds to a value called by the name of electrostatic capacity in a field of capacitor. The laminate of the present invention is characterized by having 2.0 F/cm³ or more of an electrical double layer capacity according to the above-described constant current discharge method, more preferable being 3.0 F/cm³ or higher for obtaining a higher bending, and still further preferable being 4.0 F/cm³ or higher.

The laminate of the present invention is suitable for an actuator, because the electrode layer has an interface with a polymer electrolyte. Particularly, it is preferred that the laminate is a joined body of an electrode and a polymer electrolyte, because exfoliation hardly appears in the interface of the electrode and the polymer electrolyte. The laminate is formed from a metal layer, and it may be a laminate having a two-layered structure composed of one layer each of an electrode layer and a polymer electrolyte layer or a laminate having a three-layered structure composed of two electrode layers and a single polymer electrolyte sandwiched between the electrode layers. Besides, an actuator of the present invention may be formed into a film-like, a plate-like, a cylinder-like, a column-like, and a tube-like shape.

(Use Application)

In accordance with the above-described method for electroless plating, a laminate which exhibits a remarkable bending as an actuator element in the case when a voltage is applied to an electrode layer can be obtained. Since the laminate provides a remarkable bending, it is particularly suitable for a use application where in much more mechanical energy is required. More specifically, the laminate can be suitably used for an actuator element in a use application including a micromachine or artificial muscles wherein high mechanical energy is required. In even conventional use applications, the actuator element of the present invention can be driven by a low applied voltage. The actuator element may have a well-known structure. For instance, the actuator element of the present invention may be constituted as in the actuator element described in Patent Application Laid-Open No. 8-10336 in such that a pair of electrodes are formed on the inner or outer circumferential surface of a cylindrical polymer electrolyte so as to occupy the positions between which the polymer electrolyte is sandwiched, whereby the resulting actuator element is deformed (bent) when a voltage is applied.

The above-described laminate may be used as an actuator element, or it may be suitably applied to a micromachine or medical implements wherein the actuator element is used for its driving part such as tweezers, scissors, forceps, snare, laser scalpel, spatula and clip in a microsurgery technology. In addition, the laminate may be also suitably used in articles applied in water containing mechanical instruments wherein the actuator element is used for its driving part, for example, industrial instruments such as various sensors or machine tools used for detection and repair, health appliances, humidity indicator, control devices for humidity indicator, soft manipulator, underwater valve, and soft carrier; or hobby articles such as underwater mobile toys such as goldfish maquette or artificial mobile bait, and propeller fins.

A laminate obtained by a method for electroless plating of the present invention and the laminate of the present invention are ones which can be driven as an actuator element, and may be used as an actuator element wherein displacement in a bending appears. Furthermore, when the laminate is combined with a device for converting a bending motion into a linear motion, the laminate element is made to be an actuator which produces linear displacement. An actuator element which produces linear displacement or displacement in a bending may be used as a driving part for producing linear driving force or a driving part for producing driving force of transferring on an orbit of a track type formed from a circular arc section. In addition, the actuator element may also be used as a pressing part which brings about a linear action.

More specifically, the actuator element can be suitably used for a driving part for producing linear driving force or a driving part for producing driving force of transferring on an orbit of a track type formed from a circular arc section, or a pressing part for providing a linear action or a rounded action in office automation equipment, antenna, devices for riding a person on a bed or chair, medical instruments, engines, optical equipment, fixtures, side trimers, vehicles, elevator machines, food-processing devices, cleaning devices, measuring instruments, testing equipment, control equipment, machine tools, processing machinery, electronics devices, electron microscopes, electric shavers, electric toothbrushes, manipulators, masts, children's play facilities, amusement equipment, simulation devices for passenger car, supporting tools for vehicle combat crews, and extension devices for accessory equipment used for aircraft. The actuator element may be used as a driving part for producing linear driving force or a driving part for producing driving force of transferring on an orbit of a track type formed from a circular arc section, or a pressing part for providing a linear action in valves, brakes, and locking devices used in general machines including the above-described machineries such as office automation equipment, measuring instruments and the like. In all-around machineries and instruments other than that described above, the actuator element may be suitably used for a driving part of positioning devices, a driving part of gyroscopes, a driving part of elevator machines, a driving part of carrier devices, a driving part of moving means, a driving part of regulating means for an amount, a direction and the like, a driving part of adjusting devices used for shafts and the like, a driving part of guidance systems, and a pressing part of pressing devices. Furthermore, since the actuator element can perform a rotational motion, it may be used also for a driving part of switching means, a driving part of reversing means for conveying products, a driving part of take-up means for wires and the like, a driving part of drawing means, and a driving part of swing devices in horizontal direction such as an oscillating motion.

The above-described actuator element can be suitably used for the driving parts illustrated hereinafter. Namely, the actuator element may be used suitably for a driving part of an ink jet part in ink jet printers for CAD printers and the like, a driving part which displaces a light axial direction of light beam in a printer, a head driving part of a disk drive such as an external storage unit as well as a driving part of an adjusting means for pressing contact force of a paper in a sheet feeder in imaging devices including printers, copying machines, and facsimile machines.

The actuator element may be used for a driving part of a driving mechanism for moving and setting out a measuring section wherein a high-frequency power feeding section such as a frequency sharing antenna used for radio astronomy is transferred to the secondary focus, a power feeding section, a driving part of a vehicle equipped with a lifting mechanism in a mast or an antenna of a pneumatically operating telescopically moving mast (telescoping mast).

The above-described actuator element may be suitably applied, for example, to the driving parts illustrated hereinafter: they are a driving part of a massaging part in a chair massager, a driving part of care or medical use beds, a driving part in a posture control system such as an electrically operating reclining chair, a driving part of a telescopically moving rod for freely standing and falling a backrest/ottoman in a reclining chair used for a massager or a comfort chair, a driving part used for revolvable movement of a backrest or a leg rest in a retractable chair in furniture on which a person rides or a caring bed as well as a driving part for posture control of an uprising chair.

The above-described actuator element may be suitably applied, for example, to the driving parts illustrated hereinafter: they are a driving part of inspection apparatus, a driving part of a pressure measuring device for blood pressure and the like used in an extracorporeal blood treatment apparatus, a driving part of catheter, endoscopic instrument, forceps and the like, a driving part of a cataract surgery instrument using ultrasonic waves, a driving part of an excising device for jaw movement instrument, a driving part of a means for telescoping relatively a chassis member in a hoist for valetudinarians, and a driving part for hoisting, moving or posture control of a caring bed.

The above-described actuator element may be suitably applied, for example, to the driving parts illustrated hereinafter: they are a driving part of a vibration isolator which attenuates vibrations transferred from a vibration generating part such as an engine to a vibration receiving section such as a frame, a driving part of a valve operating means for intake and exhaust valves in an internal combustion engine, a driving part of a fuel control system in an engine, and a driving part of a fuel injection system in an engine such as a diesel engine.

The above-described actuator element may be suitably applied, for example, to the driving parts illustrated hereinafter: they are a driving part of a compensation means in an image pickup apparatus provided with an image stabilizing function, a driving part of a lens driving mechanism in a home video camera, a driving part of a mechanism for driving a mobile lens group in an optical instrument such as still camera, and video camera, a driving part of an autofocusing part in a camera, a driving part of a barrel used in an image pickup apparatus such as camera, and video camera, a driving part of an autoguider by which light is introduced into an optical telescope, a driving part of a driving mechanism or a barrel in an optical device having two optical systems such as a stereo-scopic vision camera or binoculars, a driving part or a pressing part for providing compression force on a fiber used for converting wavelength in a fiber type wavelength variable filter applied to optical communications, optical information processing, and optical measurement, a driving part of optic axes matching means, and a driving part of a shutter mechanism in a camera.

The actuator element may be suitably used for a pressing part of a fixture for caulking a hose fitting to a hose main body to fix it.

The above-described actuator element may be suitably applied, for example, to the driving parts illustrated hereinafter: they are a driving part of coil springs used in suspension of automobiles, a driving part of a fuel filler lid opener for unlocking a fuel filler lid in a vehicle, a driving part in extending and retracting driving of a bulldozer blade, and a driving part of a driving device for switching automatically a change gear ratio of an automobile transmission or automatically engaging and disengaging a clutch.

The above-described actuator element may be suitably applied, for example, to the driving parts illustrated hereinafter: they are a driving part of a lifting and lowering device in an invalid wheel chair provided with a seat lifting and lowering means, a driving part of a lifting and lowering means for smoothening a difference between steps, a driving part of a lifting, lowering and shifting means, a driving part for a lifting and lowering means in a bed of medical use, an electronically-operated bed, an electronically-operated table, an electronically-operated chair, abed of caring use, a lifting and lowering table, a CT scanner, a cabin tilting means for truck, a lifter and a variety of lifting and lowering machineries, and a driving part of loading and unloading means for a special-purpose vehicle for conveying heavy load.

The above-described actuator element may be suitably used, for example, for a driving part of a mechanism for adjusting a discharge rate of a nozzle means or the like for discharging a foodstuff in food processing apparatuses.

The actuator element may be suitably used, for example, for a driving part of carriage of cleaning devices and lifting and lowering a cleaning part.

The above-described actuator element may be suitably applied, for example, to the driving parts illustrated hereinafter: they are a driving part of a measuring part of three-dimensionally measuring equipment for measuring a profile of a plane, a driving part of stage equipment, a driving part of a sensor part in a system for detecting operating characteristics of tires, a driving part of a means for providing an initial rate of evaluation equipment for impact response in a force sensor, a driving part of a piston driving device for a piston cylinder including a borehole water permeability testing device, a driving part for moving light focus tracking type generating equipment in an elevation angle direction, a driving part of an oscillating device for a tuning mirror in a sapphire laser oscillation wavelength switching mechanism in measuring equipment including a gas density measuring apparatus, a driving part of an XY θ table in case of requiring an alignment in an inspection apparatus of a printed-circuit board or an inspection apparatus for a flat panel display such as liquid crystal, and PDP, a driving part of an adjustable aperture means used in a charged particle beam system such as an electron beam (E beam) system, and a forecast ion beam (FIB) system, a driving part of a detection part or a supporting means for an object to be measured in a flatness measuring instrument, and a driving part of a precise positioning device including assemblage of a minute device such as a semiconductor exposure device or a semiconductor inspection device, and a measuring device for a three-dimensional outline.

The above-described actuator element may be suitably used, for example, for a driving part of an electric shaver as well as for a driving part of an electric toothbrush.

The above-described actuator element may be suitably applied, for example, to the driving parts illustrated hereinafter: they are a driving part of a focal depth adjusting device used for an image pickup device of three-dimensional objects or a readout optical system commonly used for CD and DVD, a driving part of a variable mirror wherein a driving object surface is made to be an active curved surface by a plurality of actuator elements, whereby its outline is deformed to form approximately a desired curved surface, so that its focal position can be made easily in a variable state, a driving part of a disk device which can move linearly a moving unit having at least either of magnetic heads such as optical pickup, a driving part of a head feeding mechanism of a magnetic tape head actuator element assembly such as a linear tape storage system, a driving part of an imaging apparatus which is applied to a copying machine, a printer, and a facsimile of xerography, a driving part of a magnetic head loaded member, a driving part of an optical disk master exposure device which makes a focusing lens group to drive-control in the optical axis direction, a driving part of a head driving means for driving an optical head, a driving part of an information recording and reproducing device wherein information is recorded on a recording medium and the information recorded on a recording medium is reproduced, and a driving part for opening and closing a circuit breaker (circuit breaker for power distribution).

The above-described actuator element may be suitably applied, for example, to the driving parts illustrated hereinafter: they are a driving part of a press molding and vulcanizing machine for a rubber composition, a driving part of a component array apparatus for aligning components or parts to be transferred into a single row/a single layer or arraying a predetermined posture, a driving part of a compression molding apparatus, a driving part of a hold mechanism in a welding apparatus, a driving part of a bag-making and charging/packaging machine, a driving part of a working machine such as a machining center or a molding machine such as an injection molding machine, and a pressing machine, a driving part of a fluid coating machine such as a printing machine, a coating machine, and a lacquer spraying machine, a driving part of manufacturing equipment for manufacturing camshafts and the like, a driving part of a lifting gear for covering materials, a driving part of a tufting ear restricting member in a shuttleless loom, a driving part in a needle driving system of a tufting machine, a looper driving system, and a knife driving system, a driving part of a cam grinding machine or a grinding machine for grinding parts such as ultraprecision machining parts, a driving part of a brake means of a heddle frame in a textile weaving loom, a driving part of a shedding mechanism for forming an opening of warp for inserting a warp in a textile weaving loom, a driving part of a releasing means for a protective sheet for a semiconductor substrate, a driving part of a harness cord device, a driving part of an assembling means for electron gun for CRT use, a driving part of a shifter fork driving selective linear control device in a torchon lace machine for manufacturing a torchon lace which has use application in a purfle for clothing material, a table cloth, and a sheet cover, a driving part of a horizontally shifting mechanism for an anneal window driving device, a driving part of a supporting arm for a glass melting kiln forehearth, a driving part for back-and-forth movement of a rack in an exposure device for forming a fluorescent screen of a color television tube, a driving part of a torch arm in a ball bonding device, a driving part of a bonding head in XY directions, a driving part for a mounting step of chip parts or an inspection step of parts in measurement by the use of a probe, a driving part for a lifting and lowering section of a washing implement supporting member in a substrate washing apparatus, a driving part for forwarding and retracting a detection head scanning a glass substrate, a driving part of a positioning device in an exposure apparatus for transferring a pattern on a substrate, a driving part of a fine positioning device used in a submicron order in a high-precision processing field, a driving part of a positioning device in a measuring apparatus for chemical mechanical polishing tools, a driving part for positioning a stage device suitable for an exposure device and a scanning exposure device used in case of manufacturing a circuit device such as a conductor circuit element, and a liquid crystal display by means of a lithography step, a driving part of conveying works and the like or positioning means, a driving part for positioning or conveying a reticle stage or a wafer stage, a driving part of an accurate positioning stage device in a chamber, a driving part of a positioning device for a work piece or a semiconductor wafer in a chemical mechanical polishing system, a driving part of a stepper device of semiconductor, a driving part of a device for making correct positioning in an introduction station of a processing machinery, a driving part of a vibration-free device for passive vibration-free and active vibration-free used for a variety of machineries represented by processing machineries such as NC machine, and machining center, or a stepper in IC industry, a driving part for displacing a reference grid plate of a light beam scanner in the optical axis direction of the light beam in an exposure device used in a lithography step for manufacturing a semiconductor device or a liquid crystal display, and a driving part of a transferring device for transferring an article into an article processing unit in a traverse direction of a conveyor.

The actuator element may be suitably used, for example, in a driving part of a positioning means for a probe in a scanning probe microscope such as an electron microscope as well as a driving part for positioning a sample fine adjustment used in an electron microscope.

The above-described actuator element may be suitably applied, for example, to the driving parts illustrated hereinafter: they are a driving part of a joint mechanism represented by a wrist of robot arm in robots including automatic welding robots, steel-collar workers, and caring-purpose robots or manipulators, a driving part of joints other than that of a directly driving type, a driving part of a motion converting mechanism in a slidably opening and closing type fastener used in robot fingers themselves, and hands of a robot, a driving part of a micromanipulator for operating a minute object in an arbitrary state for an assembling operation of minute parts or microoperation of cells, a driving part of artificial limb prostheses such as electrically-operated artificial hands provided with openable plural fingers, a driving part of handling robots, a driving part of adaptive equipment, and a driving part of power suits.

The above-described actuator element may be suitably used, for example, in a pressing part of a device for pressing an upper rotary blade or a lower rotary blade in a side trimmer.

The above-described actuator element may be suitably applied, for example, to the driving parts illustrated hereinafter: they are a driving part of playactors in game machines such as a pinball machine, a driving part of dolls, or pet robots in amusement equipment, and a driving part of a simulation means in a car simulation apparatus.

The above-described actuator element may be used for a driving part of valves used generally in machineries including the equipment and instruments as described above, for example, it may be also suitably used in the driving parts illustrated hereinafter. They are a driving part of a valve in a reliquefaction system of evaporated helium gas, a driving part of a pressure-sensitive control valve of bellows type, a driving part of a shedding mechanism for driving a heddle frame, a driving part of a vacuum gate valve, a driving part of a solenoid-operated type control valve for a hydraulic system, a driving part of a valve in which a motion transmission device using a pivot lever is incorporated, a driving part of a valve for a movable nozzle in a rocket, a driving part of a suck back valve, and a driving part of a regulator part.

The above-described actuator element may be used, for example, in a pressing part for brakes used generally in machineries including the above-described equipment and instruments. For instance, the actuator element may suitably be used in a pressing part of control means which is suitable for emergency, security, statary or the like brakes, and brakes for elevators, or a pressing part of a brake structure or a brake system.

The above-described actuator element may be used, for example, in a pressing part for locking mechanisms used generally in machineries including the above-described equipment and instruments. For instance, the actuator element may suitably be used in a pressing part of mechanical locking means, a pressing part of a vehicle-steering locking mechanism as well as a pressing part of a power transmission device having both of a load restricting mechanism and a coupling disengaging mechanism.

In the following, the present invention is more fully described by referring to examples of the present invention and comparative examples, but it is to be noted that the present invention is not limited thereto.

### EXAMPLE 1

(Swelling Step)

A film-like polymer electrolyte (fluorocarbon polymer-base ion-exchange resin: perfluorocarboxylic acid resin; trade name “Flemion” manufactured by Asahi Glass Co., Ltd.; 1.4 meq/g ion-exchange capacity) having a film thickness of 17 μm in a dry state was immersed into methanol being a swelling solvent at 20° C. for one or more hours. A film thickness of the resultant film-like polymer electrolyte swollen was measured to calculate a ratio [a degree of swelling (%)] of an increased film thickness after swelling with respect to a dry film thickness, and the film-like polymer electrolyte was immersed into the swelling solvent so as to obtain a value (50%) shown in table 1.

(Electroless Plating Step)

After swelling a film-like polymer electrolyte in the swelling solvent, the following steps (1) to (3) were applied repeatedly over six cycles to the resultant swollen film-like polymer electrolyte to obtain a polymer electrolyte (laminate) on which a metal layer was formed.

(1) Adsorption step: The swollen polymer electrolyte was immersed in a dichlorophenanthroline gold(III)chloride aqueous solution for twelve hours thereby allowing a dichlorophenanthroline gold-(III) complex to adsorb into the molded polymer electrolyte, (2) Reduction step: the so adsorbed dichlorophenanthroline gold-(III) complex was reduced in an aqueous solution containing sodium sulfite to form a gold electrode on the above-described film-like polymer electrolyte. In this case, a temperature of the aqueous solution was maintained at 60 to 80° C., and the dichlorophenanthroline gold(III) complex was reduced for six hours while adding gradually sodium sulfite. Then, (3) Washing step: the film-like polymer electrolyte on the surface of which the gold electrode had been formed was taken out, and washed with water of 70° C. for one hour. The polymer electrolyte on which the metal layer was formed was cut out in a size of 1 mm×20 mm to obtain a laminate of example 1.

### EXAMPLE 2

A laminate of example 2 was obtained in accordance with the same manner as that of example 1 except that the immersion time was reduced, and a degree of swelling was made to be 40%.

### EXAMPLE 3

A laminate of example 3 was obtained in accordance with the same manner as that of example 1 except that a film-like polymer electrolyte (fluorocarbon polymer-base ion-exchange resin: perfluorocarboxylic acid resin; trade name “Flemion” manufactured by Asahi Glass Co., Ltd.; 1.8 meq/g ion-exchange capacity) having a film thickness of 170 μm was used as the film-like polymer electrolyte, and a methanol-water mixed solvent (methanol:water=3:7) was used as the swelling solvent.

### EXAMPLE 4

A laminate of example 4 was obtained in accordance with the same manner as that of example 1 except that a film-like polymer electrolyte (fluorocarbon polymer-base ion-exchange resin: perfluorocarboxylic acid resin; trade name “Flemion” manufactured by Asahi Glass Co., Ltd.; 1.8 meq/g ion-exchange capacity) having a film thickness of 170 μm was used as the film-like polymer electrolyte, and a methanol-water mixed solvent (methanol:water=4:6) was used as the swelling solvent.

### EXAMPLES 5 AND 6

A laminate of example 5 was obtained in accordance with the same manner as that of example 1 except that dimethyl sulfoxide (DMSO) was used in place of methanol as the swelling solvent, and further a laminate of example 6 was obtained in accordance with the same manner as that of example 1 except that N-methylpyrrolidone (NMP) was used in place of methanol as the swelling solvent.

### EXAMPLE 7

A laminate of example 7 was obtained in accordance with the same manner as that of example 1 except that the steps (1) to (3) in example 1 were repeated over four cycles.

### EXAMPLE 8

A laminate of example 8 was obtained in accordance with the same manner as that of example 1 except that a film-like polymer electrolyte (perfluorocarboxylic acid resin; tradename “Flemion” manufactured by Asahi Glass Co., Ltd.) having 1.1 meq/g ion-exchange capacity was used in place of the film-like polymer electrolyte having 1.4 meq/g ion-exchange capacity.

### EXAMPLE 9

A laminate of example 9 was obtained in accordance with the same manner as that of example 1 except that the immersion time was prolonged so as to obtain 80% degree of swelling, while the cycles of the steps (1) to (3) in example 1 were reduced to a single cycle.

### EXAMPLE 10

A laminate of example 10 was obtained in accordance with the same manner as that of example 1 except that prior to the immersion in methanol, a step wherein a film-like polymer electrolyte was immersed in 10% aqueous solution of TEAOH at 20° C. for about two hours was applied, and that the cycles of the steps (1) to (3) in example 1 were reduced to a single cycle.

### EXAMPLE 11

A laminate of example 11 was obtained in accordance with the same manner as that of example 1 except that a 10% methanol mixed solution of TEAOH was used as a swelling solvent, and a polymer electrolyte was immersed in the swelling solvent so as to obtain 120% degree of swelling, and that the cycles of the steps (1) to (3) in example 1 were reduced to a single cycle.

### EXAMPLE 12

A laminate of example 12 was obtained in accordance with the same manner as that of example 1 except that a 10% methanol mixed solution of tetrapropylammonium hydroxide was used as a swelling solvent, and a polymer electrolyte was immersed in the swelling solvent so as to obtain 140% degree of swelling, and that the cycles of the steps (1) to (3) in example 1 were reduced to a single cycle.

### EXAMPLE 13

A laminate of example 13 was obtained in accordance with the same manner as that of example 1 except that a 10% tetraethyl-ammonium hydroxide (TEAOH) aqueous solution was used in place of methanol as a swelling solvent, and a polymer electrolyte was immersed in the swelling solvent so as to obtain 30% degree of swelling.

### COMPARATIVE EXAMPLES 1 TO 3

Different from the above-described examples, electroless plating was carried out without accompanying the swelling step. The following steps (1) to (3) were applied repeatedly over six cycles to a film-like polymer electrolyte (fluorocarbon polymer-base ion-exchange resin: perfluorocarboxylic acid resin; trade name “Flemion” manufactured by Asahi Glass Co., Ltd.; ion-exchange capacities: shown in table 3) having a film thickness of 170 μm in a dry state to obtain a polymer electrolyte on which a metal layer was formed. (1) Adsorption step: The polymer electrolyte was immersed in a dichlorophenanthroline gold(III)chloride aqueous solution for twelve hours thereby allowing a dichlorophenanthroline gold(III)complex to adsorb into the molded polymer electrolyte, (2) Reduction step: the so adsorbed dichlorophenanthroline gold(III) complex was reduced in an aqueous solution containing sodium sulfite to form a gold electrode on the film-like polymer electrolyte. In this case, a temperature of the aqueous solution was maintained at 60 to 80° C., and the dichlorophenanthroline gold(III) complex was reduced for six hours while adding gradually sodium sulfite. Then, (3) Washing step: the film-like polymer electrolyte on the surface of which the gold electrode had been formed was taken out, and washed with water of 70° C. for one hour. The polymer electrolyte on which the metal layer was formed was cut out in a size of 1 mm×20 mm to obtain each of laminates of comparative examples 1 to 3. The resulting laminates of comparative examples 1 to 3 are shown in table 3 wherein each of degrees of swelling in comparative examples 1 to 3 of table 3 was measured after twelve hours of immersion in dichlorophenanthroline gold(III)chloride aqueous solution in the first adsorption step.

### COMPARATIVE EXAMPLE 4

As a result of such trial that a laminate of comparative example 4 would be obtained in the swelling step described in example 1 in accordance with such a manner that a polymer electrolyte was immersed in a methanol single solvent at 60° C. until a degree of swelling of 120% was achieved, the polymer electrolyte was gelled during methanol immersion, so that the laminate having a predetermined shape could not be obtained.

[Evaluation]

(Displacement Distance)

The laminates of examples 1 to 12 as well as those of comparative examples 1 to 3 and 5 were used as work electrodes, while platinum plates were used as counter electrodes for these work electrodes, respectively. Each of the work electrodes and each of the counter electrodes were maintained in water, an electric current source was connected across ends of the respective electrodes through a lead wire, and a voltage (a rectangular wave of 1 Hz, 2.0V) was applied across the electrodes to determine a bending amount of displacement wherein each amount of displacement (or displacement magnitude) was determined in such that a position at 18 mm from an end of each work electrode of the laminates in examples 1 to 12 as well as comparative examples 1 to 3 and 5 was fixed, and a displacement magnitude appeared over an area from the fixed position to the extreme end thereof in case of applying a voltage was determined. The results obtained are shown in tables 1 to 3.

(Electric Double Layer Capacity)

Electric double layer capacity (measuring method A) was determined in a measuring condition of 0.1 mV/sec, and ±0.5 V in accordance with a well-known cyclic voltammetry. For actual measurements of electric double layer capacity according to cyclic voltammetry, a trade name “Potentio Galvanostat Model 263A” (manufactured by Princeton Applied Research Corporation) was used. On the one hand, actual measurements of electric double layer capacity (measuring method B) according to a constant current discharge method were those determined pursuant to the above-described standard number EIAJ RC-2377 by using a trade name “HJ-201B” (manufactured by Hokuto Co., Ltd.). In examples 1 to 12 as well as comparative examples 1 to 3 and 5, a constituent ion of a laminate element in measurement of electric double layer capacity is sodium ion. The results of determined measurements are shown in tables 1 to 3.

TABLE 1

| | Example | | | | | |
|---|---|---|---|---|---|---|
| | 1 | 2 | 3 | 4 | 5 | 6 |
| Ion Exchange Capacity (meq/g) | 1.4 | 1.4 | 1.8 | 1.8 | 1.4 | 1.4 |
| Swelling Solution | MeOH | MeOH | MeOH:Water = | MeOH:Water = | DMSO | NMP |
| | | | 3:7 | 4:6 | | |
| Degree of Swelling (%) | 50 | 40 | 50 | 70 | 30 | 30 |
| Number of Cycles in Electroless Plating Step | 6 | 6 | 6 | 6 | 6 | 6 |
| Electric Double Layer Capacity | | | | | | |
| Upper Column: Measuring Method A | 8.4 | 8.1 | 6.0 | 5.8 | 7.0 | 6.8 |
| Lower Column: Measuring Method B | 4.9 | 4.8 | 3.5 | 3.4 | 4.1 | 4.1 |
| Displacement Magnitude (mm) | 25 | 24 | 21 | 20 | 22 | 21 |

Note)
Electric Double Layer Measuring Method
Measuring Method A: Cyclic Voltammetry (Unit: mF/cm²)
Measuring Method B: Constant Current Discharge Method (Unit: F/cm³)

TABLE 2

| | Example | | | | | | |
|---|---|---|---|---|---|---|---|
| | 7 | 8 | 9 | 10 | 11 | 12 | 13 |
| Ion Exchange Capacity (meq/g) | 1.4 | 1.1 | 1.4 | 1.4 | 1.4 | 1.4 | 1.4 |
| Swelling Solution | MeOH | MeOH | MeOH | TEAOH→MeOH | MeOH + TEAOH | MeOH + TPAOH | TPAOH |
| Degree of Swelling (%) | 50 | 50 | 80 | 120 | 120 | 140 | 30 |
| Number of Cycles in Electroless Plating Step | 4 | 6 | 1 | 1 | 1 | 1 | 6 |
| Electric Double Layer Capacity | | | | | | | |
| Upper Column: Measuring Method A | 5.0 | 5.0 | 5.6 | 8.5 | 8.8 | 11.8 | 3.4 |
| Lower Column: Measuring Method B | 2.9 | 2.9 | 3.3 | 5.0 | 5.2 | 6.9 | 2.0 |
| Displacement Magnitude (mm) | 15 | 15 | 16 | 26 | 27 | 33 | 15 |

Note)
Electric Double Layer Measuring Method
Measuring Method A: Cyclic Voltammetry (Unit: mF/cm²)
Measuring Method B: Constant Current Discharge Method (Unit: F/cm³)

TABLE 3

| | Comparative Example | | | |
|---|---|---|---|---|
| | 1 | 2 | 3 | 4 |
| Ion Exchange Capacity (meq/g) | 1.4 | 1.8 | 1.1 | 1.4 |
| Swelling Solution | Water | Water | Water | MeOH |
| Degree of Swelling (%) | 5 | 5 | 5 | 120 |
| Number of Cycles in | 6 | 6 | 6 | — |
| Electroless Plating Step | | | | |
| Electric Double Layer Capacity | | | | |
| Upper Column: Measuring | 1.5 | 2.5 | 1.0 | — |
| Method A | | | | |
| Lower Column: Measuring | 0.9 | 1.5 | 0.9 | — |
| Method B | | | | |
| Displacement Magnitude (mm) | 10 | 12 | 7 | — |

Note)
Electric Double Layer Measuring Method
Measuring Method A: Cyclic Voltammetry (Unit: mF/cm²)
Measuring Method B: Constant Current Discharge Method (Unit: F/cm³)

With respect to the laminate in example 1 and the laminate in comparative example 1, displacement magnitudes were determined in the case where applied voltages (V) are ±2.0, ±1.5, and ±1.0, respectively. The results are shown in table 4.

TABLE 4

| | | | Comparative |
|---|---|---|---|
| | | Example 1 | Example 1 |
| Degree of Swelling (%) in Swelling Step | | 50 | 10 |
| Displacement | Applied Voltage ± 2.0 (V) | 25 | 11 |
| Magnitude | Applied Voltage ± 1.5 (V) | 17 | 6 |
| (mm) | Applied Voltage ± 1.0 (V) | 12 | 2 |

The laminates in examples 1 and 2 obtained in accordance with the electroless plating method are those corresponding to the case where their degrees of swelling are 50% and 40%, in other words, the case where each thickness of the polymer electrolytes applied in a swollen state (a film thickness of a swollen film-like polymer electrolyte) is 150% and 140% with respect to each thickness (a dry film thickness) of the polymer electrolytes in a dry state, and in this case, displacement magnitudes were 25 mm and 24 mm. On the one hand, the laminate in comparative example 1 being the one obtained by a conventional electroless plating method is that corresponding to the case where its degree of swelling is 5% in a swelling step, in other words, the case where a thickness of the polymer electrolyte applied in a swollen state (a film thickness of a swollen film-like polymer electrolyte) is 105% with respect to a thickness (a dry film thickness) of the polymer electrolyte in a dry state, and in this case, displacement magnitude was 11 mm. When the laminates in examples 1 and 2 are allowed to drive as actuators, respectively, they exhibited two or more times excellent displacement magnitudes than that of a laminate obtained in accordance with a conventional method.

The laminates in examples 3 and 4 are those corresponding to the case where a mixed solvent containing a good solvent in swelling step wherein a degree of swelling is 30%, in other words, the case where each thickness of the polymer electrolytes applied in a swollen state (a film thickness of a swollen film-like polymer electrolyte) is 130% with respect to each thickness (a dry film thickness) of the polymer electrolytes in a dry state, and in this case, displacement magnitudes were 21 mm and 20 mm, respectively. On the one hand, the laminate in comparative example 2 is that corresponding to the case where an ion-exchange resin having the same ion-exchange capacity as that of the laminates of examples 2 and 3 wherein its degree of swelling is 5% in a swelling step, in other words, the case where a thickness of the polymer electrolyte applied in a swollen state (a film thickness of a swollen film-like polymer electrolyte) is 105% with respect to a thickness (a dry film thickness) of the polymer electrolyte in a dry state, and in this case, displacement magnitude was 11 mm. When the laminates in examples 3 and 4 are allowed to drive as actuators, respectively, they exhibited two or more times excellent displacement magnitudes than that of a laminate obtained in accordance with a conventional method.

Likewise, the laminates in examples 5 and 6 are those corresponding to the case where a good solvent other than methanol was used as a swelling solvent. When these laminates compared with the laminate in comparative example 3 wherein an ion-exchange resin having the same ion-exchange capacity of 1.1 meq/g as that of examples 5 and 6, they exhibited two or more times excellent displacement magnitudes than that of the laminate in comparative example 3.

The laminate in example 7 is that having the same displacement magnitude as the laminate in comparative example 1, when the former laminate is driven as an actuator. However, when the method for electroless plating according to the present invention is applied, it becomes sufficient to repeat cycles of adsorption, reduction, and washing steps over four times. As a result, one third of a process step can be reduced as compared with that of a conventional electroless plating method. A cycle of adsorption, reduction, and washing steps requires all-night continuous operation for one day. To obtain a laminate according to conventional electroless plating, at least six days are required, while only five days are required in accordance with the method for electroless plating of the present invention, even if one day is required for a swelling step. Accordingly, it is possible to manufacture the above-described laminate in a working-day manufacture operational fashion, so that its manufacture workability is good from a viewpoint of industry.

Furthermore, as in examples 10 to 12, since a swelling step wherein a basic salt is used is added, it is possible to remarkably swell a polymer electrolyte even in a case where the polymer electrolyte becomes gelled by the use of a good solvent alone. Thus, when a degree of swelling of a polymer electrolyte is elevated sufficiently by utilizing a basic salt in a swelling step, a laminate having performance being by no means inferior to that of laminates in other examples wherein a good solvent is used alone as in the laminates in examples 10 to 12, even if the number of cycles in electroless plating method is reduced to only one time. More specifically, when either a swelling step wherein a good solvent containing a basic salt is used in place of a good solvent alone is applied, or a swelling step wherein an aqueous solution into which a basic salt is dissolved is added before or after a swelling step wherein a good solvent is used alone, a period of time required for the following electroless plating steps can be reduced. Hence, manufacturing efficiency can be further increased as a whole in a manufacture of the laminates of the present invention.

The laminate in example 13 is the one wherein a metal electrode is formed on a polymer electrolyte which is obtained by swelling the polymer electrolyte with the use of 10% aqueous solution of tetraethylammonium hydroxide as an aqueous solution of a salt containing an ion exchangeable with an exchange group contained in an ion-exchange resin, and then, effecting electroless plating. This laminate exhibited also an excellent displacement magnitude.

Moreover, the laminate in example 1 obtained in accordance with the method for electroless plating of the present invention exhibits the higher difference in displacement magnitude in comparison with the laminate in comparative example 1, when the lower voltage is applied as shown in table 4. A displacement magnitude of the laminate in example 1 in the case where an applied voltage is ±1.0 (V) is six times higher or more than that of the laminate in comparative example 1, and this is substantially equal displacement magnitude to that in case of applying a voltage of ±2.0 (V). Namely, when a laminate obtained by the method for electroless plating of the present invention is applied to an actuator a use application of which requires the same displacement magnitude as that of a conventional one, energy efficiency of the former laminate is better than that obtained by a conventional electroless plating method, whereby it is possible to reduce an applied voltage, so that consumption energy can be remarkably decreased. This result may be considered to be based on that an electric double layer capacity of a laminate obtained by the method for electroless plating of the present invention is higher than that of a laminate obtained by a conventional electroless plating method.

### INDUSTRIAL APPLICABILITY

The method for electroless plating according to the present invention is applicable for manufacturing a laminate of the present invention obtained by forming a metal layer on a polymer electrolyte. In the laminate of the present invention, when a voltage is applied, for example, to the metal layer, the laminate is bent, so that it is possible to use as an actuator. Specifically, the laminate of the present invention may be used in a driving part of positioning devices, posture control systems, lifting and lowering equipment, carrier devices, travelling apparatuses, regulating machines, adjusting devices, guidance systems, hinge joint means, switching arrangements, reversing means, take-up units, traction apparatuses, swing devices and the like, or in a pressing part of pressing means. Furthermore, since an electric double layer is formed between the metal layer and the polymer electrolyte in the laminate of the present invention, the laminate of the present invention may also be used as an electric double layer capacitor.

1. A method for electroless plating, wherein:
the method for electroless plating is that for applying to a polymer electrolyte;
the method for electroless plating contains a pre-treatment step;
the pre-treatment step is a swelling step for swelling the polymer electrolyte by means of permeation of a good solvent or a mixed solvent containing a good solvent; and
the swelling step is a step for making a thickness of the polymer electrolyte in a swollen state to be 110% or more that of the polymer electrolyte in a dry state.

2. The method for electroless plating for applying to a polymer electrolyte as claimed in claim 1, characterized in that the swelling step is a step for making a thickness of the polymer electrolyte in a swollen state to be 110 to 3000% with respect to that of the polymer electrolyte in a dry state.

3. A method for manufacturing a laminate comprising a metal layer and a polymer electrolyte, wherein:
the manufacturing method is that for applying electroless plating to a polymer electrolyte;
the method for electroless plating contains a pre-treatment step;
the pre-treatment step is a swelling step for swelling the polymer electrolyte by means of permeation of a good solvent or a mixed solvent containing a good solvent;
the swelling step is a step for making a thickness of the polymer electrolyte in a swollen state to be 110% or more that of the polymer electrolyte in a dry state;
after the swelling step, an adsorption step and a reduction step are carried out;
the adsorption step is a step for adsorbing a metal complex to the polymer electrolyte; and
the reduction step is a step for allowing a reductant solution to be in contact with the polymer electrolyte to which the metal complex has been adsorbed.

4. The method for manufacturing a laminate as claimed in claim 3, characterized in that the swelling step allows a good solvent or a mixed solvent containing a good solvent to permeate into the polymer electrolyte, whereby a degree of crystallization of the polymer electrolyte is reduced, so that intertwist of side chains containing at least functional groups in a polymer constituting the polymer electrolyte is moderated.

5. The method for manufacturing a laminate as claimed in claim 3, wherein the good solvent is methanol.

6. The method for manufacturing a laminate as claimed in claim 3, wherein the polymer electrolyte is an ion-exchange resin, and the good solvent is a mixed solution consisting of a basic salt and methanol.

7. A method for electroless plating, wherein:
the method for electroless plating is that for applying to a polymer electrolyte;
the method for electroless plating contains a pre-treatment step;
the pre-treatment step is a swelling step for swelling the polymer electrolyte by means of permeation of an aqueous solution of a salt; and
the swelling step is a step for making a thickness of the polymer electrolyte in a swollen state to be 110% or more that of the polymer electrolyte in a dry state.

8. A method for manufacturing a laminate comprising a metal layer and a polymer electrolyte, wherein:
the manufacturing method is that for applying electroless plating to a polymer electrolyte;
the method for electroless plating contains a pre-treatment step;
the pre-treatment step is a swelling step for swelling the polymer electrolyte by means of permeation of an aqueous solution of a salt;
the swelling step is a step for making a thickness of the polymer electrolyte in a swollen state to be 110% or more that of the polymer electrolyte in a dry state;
after the swelling step, an adsorption step and a reduction step are carried out;
the adsorption step is a step for adsorbing a metal complex to the polymer electrolyte; and
the reduction step is a step for allowing a reductant solution to be in contact with the polymer electrolyte to which the metal complex has been adsorbed.

9. A laminate comprising an electrode layer and a polymer electrolyte layer, wherein the electrode layer is a metal layer, and an electric double layer capacity in an interface of the electrode layer and the polymer electrolyte layer measured by cyclic voltammetry is 3 mF/cm² or more as a value converted in such that a dry film thickness of the polymer electrolyte is 170 μm.

10. A laminate comprising an electrode layer and a polymer electrolyte layer, wherein the electrode layer is a metal layer, and an electric double layer capacity in an interface of the electrode layer and the polymer electrolyte layer measured by a constant current discharge method is 2.0 F/cm³ or more.

11. Positioning devices, posture control systems, lifting and lowering equipment, carrier devices, travelling apparatuses, regulating machines, adjusting devices, guidance systems, hinge joint means, switching arrangements, reversing means, take-up units, traction apparatuses, and swing devices, wherein the laminate as claimed in claim 9 is used for a driving part thereof.

12. Pressing means wherein the laminate as claimed in claim 9 is used for a pressing part thereof.

13. The method for manufacturing a laminate as claimed in claim 4, wherein the good solvent is methanol.

14. The method for manufacturing a laminate as claimed in claim 4, wherein the polymer electrolyte is an ion-exchange resin, and the good solvent is a mixed solution consisting of a basic salt and methanol.

15. Pressing means wherein the laminate as claimed in claim 10 is used for a pressing part thereof.
